(19) United States
(12) Patent Application Publication
(10) Pub. No.: US 2026/0343568 A1
(43) Pub. Date: Oct. 29, 2026

(54) PSFCH TRANSMISSION POWER CONFIGURATION METHOD AND APPARATUS

(71) Applicant: Beijing Xiaomi Mobile Software Co., Ltd., Beijing (CN)

(72) Inventor: Rui ZHOU, Beijing (CN)

(73) Assignee: Beijing Xiaomi Mobile Software Co., Ltd., Beijing (CN)

(21) Appl. No.: 19/119,664

(22) PCT Filed: Oct. 10, 2022
(86) PCT No.: PCT/CN2022/124232

§ 371 Date: Apr. 9, 2025

(51) Int. Cl. H04W 72/25; H04W 52/14; H04W 52/36

(52) U.S. Cl. CPC H04W 72/25; H04W 52/14; H04W 52/367

(57) ABSTRACT

A physical sidelink feedback channel (PSFCH) transmission power configuration method, a communication apparatus, and a storage medium are provided. The method comprises: determining actual transmission powers of PSFCHs according to a transmission time-frequency resource actually configured for the PSFCHs and one or more resource pools corresponding to the PSFCHs; and sending configuration information to a terminal device, wherein the configuration information is configured for configuring the actual transmission powers of the PSFCHs.

### CROSS-REFERENCE TO RELATED APPLICATIONS

The present disclosure is a U.S. national phase of PCT Application No. PCT/CN2022/124232 filed on Oct. 10, 2022, the content of which is hereby incorporated by reference in its entirety.

### TECHNICAL FIELD

The present disclosure relates to a field of communication technologies, and in particular to a PSFCH transmission power configuration method and apparatus.

### BACKGROUND

A sidelink communication manner is introduced to support direct communication between terminal devices. In the sidelink communication, a physical sidelink feedback channel (PSFCH) is introduced. The PSFCH may be for feeding back whether the terminal device successfully transmits data in a corresponding physical sidelink shared channel (PSSCH).

### SUMMARY

A first aspect of embodiments of the present disclosure provides a PSFCH transmission power configuration method, including: determining actual transmission powers of PSFCHs according to a transmission time-frequency resource actually configured for the PSFCHs and one or more resource pools corresponding to the PSFCHs; and sending configuration information to a terminal device, where the configuration information is configured for configuring the actual transmission powers of the PSFCHs.

A second aspect of the embodiments of the present disclosure provides a communication apparatus. The communication apparatus includes a processor, and the processor, when invoking a computer program in a memory, performs the method in the first aspect.

A third aspect of the embodiments of the present disclosure provides a computer-readable storage medium, configured to store instructions used for the above communication apparatus. When the instructions are executed, the communication apparatus performs the method in the first aspect.

### BRIEF DESCRIPTION OF DRAWINGS

In order to more clearly illustrate technical solutions in the embodiments of the present disclosure or in the background, the accompanying drawings that need to be used in the embodiments of the present disclosure or the background will be described below.

FIG. 1 is a schematic architectural diagram of a communication system provided by an embodiment of the present disclosure.

FIG. 2 is a schematic flowchart of a PSFCH transmission power configuration method provided by an embodiment of the present disclosure.

FIG. 3 is a schematic flowchart of another PSFCH transmission power configuration method provided by an embodiment of the present disclosure.

FIG. 4 is a schematic flowchart of another PSFCH transmission power configuration method provided by an embodiment of the present disclosure.

FIG. 5 is a schematic flowchart of another PSFCH transmission power configuration method provided by an embodiment of the present disclosure.

FIG. 6 is a schematic flowchart of another PSFCH transmission power configuration method provided by an embodiment of the present disclosure.

FIG. 7 is a schematic flowchart of another PSFCH transmission power configuration method provided by an embodiment of the present disclosure.

FIG. 8 is a schematic structural diagram of a communication apparatus provided by an embodiment of the present disclosure.

FIG. 9 is a schematic structural diagram of another communication apparatus provided by an embodiment of the present disclosure.

FIG. 10 is a schematic structural diagram of a chip provided by an embodiment of the present disclosure.

### DETAILED DESCRIPTION

In order to better understand the PSFCH transmission power configuration method disclosed in the embodiments of the present disclosure, a communication system applied to the embodiments of the present disclosure is described firstly below.

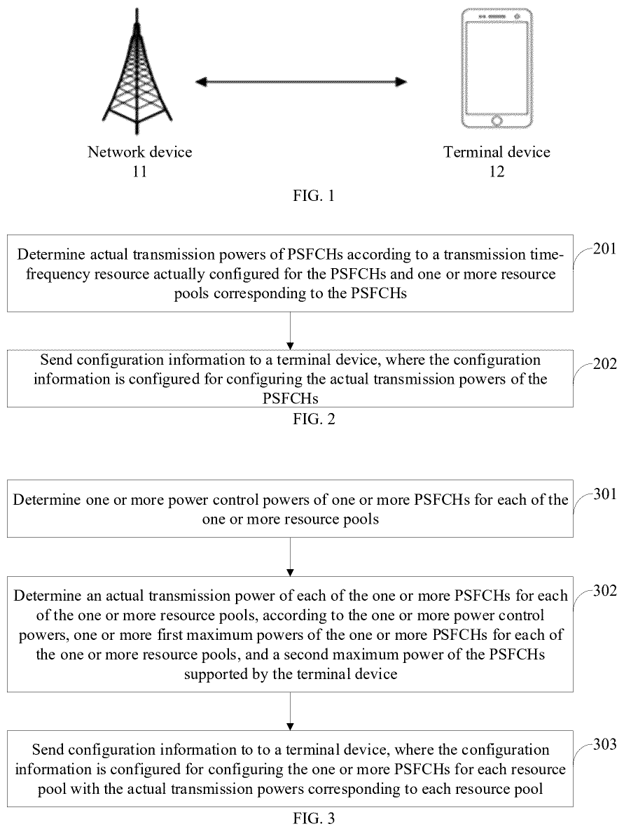

Referring to FIG. 1, FIG. 1 is a schematic architectural diagram of a communication system provided by an embodiment of the present disclosure. The communication system may include, but is not limited to, one network device and one terminal device. The number of devices and forms of the devices shown in FIG. 1 are only exemplary and do not constitute limitations to the embodiments of the present disclosure. In a practical application, the communication system may include two or more network devices and two or more terminal devices. The communication system shown in FIG. 1 may include one network device 11 and one terminal device 12 as an example.

It should be noted that technical solutions of the embodiments of the present disclosure may be applied to various types of communication systems, for example, a long term evolution (LTE) system, a 5th generation (5G) mobile communication system, a 5G new radio (NR) system, or other future new mobile communication systems, etc.

The network device 11 in the embodiments of the present disclosure is an entity for sending or receiving a signal on a network side. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system, etc. Specific technologies and specific device forms used by the network device are not limited in the embodiments of the present disclosure. The network device provided in the embodiments of the present disclosure may be composed of a central unit (CU) and a distributed unit (DU). The CU may also be referred to as a control unit. A protocol layer of the network device, for example a base station, may be split by a structure of a CU-DU. Functions of a part of the protocol layer are centrally controlled by the CU, and functions of the remaining part or all of the protocol layer are distributed in the DU, such that the CU centrally controls the DU.

The terminal device 12 in the embodiments of the present disclosure is an entity for receiving or sending a signal on a user side, for example a mobile phone. The terminal device may also be referred to as a terminal, user equipment (UE), a mobile station (MS), a mobile terminal (MT), etc. The terminal device may be a car with a communication function, a smart car, a mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. The embodiments of the present disclosure do not limit specific technologies and specific device forms adopted by the terminal device.

It may be understood that the communication system described in the embodiments of the present disclosure is used to describe the technical solutions in the embodiments of the present disclosure more clearly, and does not constitute a limitation on the technical solutions provided in the embodiments of the present disclosure. Those skilled in the art may know that with evolution of system architectures and emergence of new business scenarios, the technical solutions provided in the embodiments of the present disclosure are also applicable to similar technical problems.

In related technologies, the configuration of the transmission power of the PSFCH is usually a configuration of the power of the PSFCH based on downlink power control, and each PSFCH for the terminal device is configured with a same power. However, in the manner, the power of the PSFCH based on the downlink power control may be higher than maximum powers of the PSFCHs specified for some resource pools, resulting in a problem of confusion in the power configuration of the terminal device.

In the present disclosure, the network device 11 may determine the actual transmission powers of the PSFCHs according to the transmission time-frequency resource actually configured for the PSFCHs and the resource pools corresponding to the PSFCHs, to configure the actual transmission powers for the PSFCHs, which may thereby ensure the rationality of the configuration of the transmission powers of the PSFCHs and may solve the problem of the confusion in the power configuration of the terminal device.

A PSFCH transmission power configuration method and apparatus provided by the present disclosure are described in detail below with reference to the accompanying drawings.

Referring FIG. 2, FIG. 2 is a schematic flowchart of a PSFCH transmission power configuration method provided by an embodiment of the present disclosure. The method is performed by a network device. As shown in FIG. 2, the method may include but is not limited to the following steps 201-202.

At step 201, actual transmission powers of PSFCHs are determined according to a transmission time-frequency resource actually configured for the PSFCHs and one or more resource pools corresponding to the PSFCHs.

In the present disclosure, the network device may configure the time-frequency resource for the PSFCHs for the terminal device in the sidelink transmission. For example, there are a total of N PSFCHs transmitting simultaneously in a PSFCH transmission moment, that is, a sidelink frame including the PSFCHs, where the N PSFCHs correspond to a total of R resource pools, and the total numbers of the PSFCHs in the R resource pools is N. The R resource pools herein may be understood as the resource pools corresponding to the PSFCHs.

It should be noted that there may be one or more resource pools corresponding to the PSFCHs, which is not limited in the present disclosure.

In the present disclosure, the transmission time-frequency resource for the PSFCHs is configured on the resource pools of the terminal device, and each resource pool may be configured with a maximum power of the PSFCHs which is supported by a time-frequency resource in the resource pool.

In the present disclosure, the actual transmission powers of the PSFCHs may be determined according to the number of resource pools corresponding to the PSFCHs, the number of PSFCHs for each resource pool, the maximum power of the PSFCHs supported by each resource pool, and the like.

The actual transmission powers of PSFCHs for different resource pools may be the same or different, and PSFCHs belonging to the same resource pool may be configured with a same actual transmission power.

At step 202, configuration information is sent to a terminal device, where the configuration information is configured for configuring the actual transmission powers of the PSFCHs.

In the present disclosure, after the actual transmission powers of the PSFCHs are determined, the configuration information may be sent to the terminal device, to configure the actual transmission power for each PSFCH for the terminal device.

The configuration information may include the actual transmission powers of the PSFCHs for each resource pool, and the PSFCHs belonging to the same resource pool may be configured with a same actual transmission power.

In the embodiment of the present disclosure, the actual transmission powers of the PSFCHs are determined according to the transmission time-frequency resource actually configured for the PSFCHs and the resource pools corresponding to the PSFCHs, to configure the actual transmission powers for the PSFCHs, which, compared with configuring the power control power for each PSFCH for the terminal device, may ensure the rationality of the configuration of the transmission powers of the PSFCHs and thus may solve the problem of the confusion in the power configuration of the terminal device.

Referring FIG. 3, FIG. 3 is a schematic flowchart of another PSFCH transmission power configuration method provided by an embodiment of the present disclosure. The method is performed by a network device. As shown in FIG. 3, the method may include but is not limited to the following steps 301-303.

At step 301, one or more power control powers of one or more PSFCHs for each of the one or more resource pools are determined.

Each resource pool may be a resource pool corresponding to one or more PSFCHs, and PSFCHs may correspond to one or more resource pools.

In the present disclosure, an initial power, a compensation coefficient, and a downlink path loss reported by the terminal device, etc., may be obtained, and the power control powers of the PSFCHs for each resource pool are calculated according to the obtained initial power, compensation coefficient, downlink path loss, etc. A manner of calculating the power control powers of the PSFCHs for each resource pool, may refer to the following Formula (1):

$${P}_{PSFCH , one} = {P}_{O , PSFCH} + 10 {log}_{10} ( {2}^{μ} ) + {α}_{PSFCH} ▯ PL . \qquad ( 1 )$$

In Formula (1), P_{PSFCH,one} represents a power control power of a single PSFCH; P_{O,PSECH} and α_{PSECH} represent the initial power and compensation coefficient representing actually configured by the network device; PL represents the downlink path loss reported by the terminal device; and a value of μ is related to a bandwidth of a subcarrier; for example, if the bandwidth of the subcarrier is 15 kHz, the value of μ is 0; and if the bandwidth of the subcarrier is 30 kHz, the value of μ is 1.

In the present disclosure, for a same terminal device, the power control powers of the PSFCHs for all resource pools may be the same, that is, the power control power of each of the PSFCHs for each resource pool is the same.

At step 302, an actual transmission power of each of the one or more PSFCHs for each of the one or more resource pools is determined, according to the one or more power control powers, one or more first maximum powers of the one or more PSFCHs for each of the one or more resource pools, and a second maximum power of the PSFCHs supported by the terminal device.

In the present disclosure, the PSFCHs may correspond to one or more resource pools, a time-frequency resource for the PSFCHs is configured on the resource pools of the terminal device, each resource pool may correspond to one or more PSFCHs, and the network device may configure the first maximum powers for the PSFCHs for each resource pool of the terminal device with radio resource control (RRC) signaling, so that each resource pool is configured with a maximum power supported by the time-frequency resource in the resource pool.

In the present disclosure, the first maximum powers of the PSFCHs for each resource pool may be the same or different, which is not limited in the present disclosure.

In the present disclosure, the terminal device may report the maximum power of the PSFCHs supported by the terminal device, that is, the second maximum power, to the network device, so that the network device may obtain the second maximum power of the PSFCHs supported by the terminal device.

In the present disclosure, the actual transmission powers of the PSFCHs for the same resource pool are the same, and the actual transmission powers of the PSFCHs for different resource pools may be different or the same, which is not limited in the present disclosure.

In the present disclosure, for each resource pool, a smaller power value between the power control powers and the first maximum powers for each resource pool may be determined, a total power for all resource pools is determined according to the smaller power value for each resource pool, and the actual transmission powers of the PSFCHs for each resource pool are determined according to the total power and the second maximum power.

At step 303, configuration information is sent to a terminal device, where the configuration information is configured for configuring the one or more PSFCHs for each resource pool with the actual transmission powers corresponding to each resource pool.

In the present disclosure, after the actual transmission powers of the PSFCHs for each resource pool are determined, the network device may send the configuration information to the terminal device, to configure the PSFCHs for each resource pool on the terminal device with the actual transmission powers corresponding to each resource pool.

In the present disclosure, configured actual transmission powers of the PSFCHs for the same resource pool may be the same. For example, the resource pool A corresponds to 3 PSFCHs, the actual transmission powers of the PSFCHs for the resource pool A are determined as a, and each of the actual transmission powers of the 3 PSFCHs for the resource pool A may be configured as a.

Optionally, the configured actual transmission powers of the PSFCHs for the same resource pool may alternatively be less than or equal to the actual transmission powers of the PSFCHs for the resource pool. For example, a certain resource pool corresponds to 2 PSFCHs, where the actual transmission power of one PSFCH may be configured as b, and the actual transmission power of the other PSFCH may be configured as a value less than b.

In the embodiments of the present disclosure, the power control powers of the PSFCHs for each resource pool is determined, the actual transmission powers of the PSFCHs for each resource pool are determined according to the power control powers, the first maximum powers of the PSFCHs for each resource pool, and the second maximum power of the PSFCHs supported by the terminal device, and the configuration information is sent to the terminal device, to configure the PSFCHs for each resource pool with the actual transmission powers corresponding to each resource pool. Therefore, the actual transmission powers of the PSFCHs for each resource pool are determined according to the power control powers, the first maximum powers corresponding to each resource pool, and the second maximum power of the PSFCHs supported by the terminal device, and the actual transmission powers of the PSFCHs for each resource pool are configured to the PSFCHs for each resource pool, which, compared with configuring the power control power for each PSFCH for the terminal device, may ensure the rationality of the configuration of the transmission powers of the PSFCHs and thus may solve the problem of the confusion in the power configuration of the terminal device.

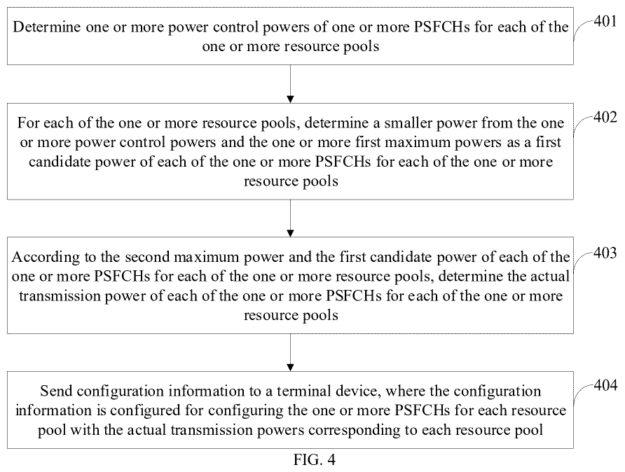

Referring FIG. 4, FIG. 4 is a schematic flowchart of another PSFCH transmission power configuration method provided by an embodiment of the present disclosure. The method is performed by a network device. As shown in FIG. 4, the method may include but is not limited to the following steps 401-404.

At step 401, one or more power control powers of one or more PSFCHs for each of the one or more resource pools are determined.

In the embodiment of the present disclosure, the step 401 may be respectively implemented in any manner in various embodiments of the present disclosure, which is not limited in this embodiment of the present disclosure, and will not be repeated.

At step 402, for each of the one or more resource pools, a smaller power from the one or more power control powers and the one or more first maximum powers is determined as a first candidate power of each of the one or more PSFCHs for each of the one or more resource pools.

In the present disclosure, for each resource pool, the network device may compare the power control powers with the first maximum powers to determine a smaller power from the power control powers and the first maximum powers, and take the smaller power as the first candidate power of each of the PSFCHs for each resource pool.

For example, there are a total of N PSFCHs transmitting simultaneously in a PSFCH transmission moment, that is, a sidelink frame including the PSFCHs, where the N PSFCHs correspond to a total of T resource pools, the resource pool Ri correspond to Ki PSFCHs transmitting, which meets

$$N = {\sum }_{i = 1}^{T} {K}_{i} ;$$

a manner of determining the first candidate powers of the PSFCHs for the resource pool Ri is as shown in the following Formula (2) (in this embodiment, the first candidate powers of Ki PSFCHs for the resource pool Ri are all the same):

$${PSFCHR}_{{R}_{i}} = min \{ {P}_{PSFCH , one} , sl - maxTransPower \} . \qquad ( 2 )$$

In Formula (2) PSFCH_{R}_{ᵢ} represents the first candidate powers of the PSFCHs for the resource pool Ri; P_{PSFCH,one} represents the power control power; and sl-maxTransPower represents the first maximum powers of the PSFCHs for the resource pool Ri.

In the present disclosure, since the first maximum powers of the PSFCHs for different resource pools may be different, the first candidate powers corresponding to the different resource pools may be the same or different, which is not limited in the present disclosure.

At step 403, according to the second maximum power and the first candidate power of each of the one or more PSFCHs for each of the one or more resource pools, the actual transmission power of each of the one or more PSFCHs for each of the one or more resource pools is determined.

In the present disclosure, one resource pool may correspond to a plurality of PSFCHs; therefore, the network device may determine the total power of the PSFCHs for all the resource pools according to the number of the PSFCHs for each resource pool and the first candidate powers of the PSFCHs for each resource pool, compare the total power of the PSFCHs for all the resource pools with the second maximum power, and determine the actual transmission power of each of the PSFCHs for each resource pool according to the comparison result.

For example, if the total power of the PSFCHs for all the resource pools is less than the second maximum power, it indicates that the terminal device can support the first candidate powers of the PSFCHs for each resource pool, the first candidate powers of the PSFCHs for each resource pool may be taken as the actual transmission powers of the PSFCHs for each resource pool.

At step 404, configuration information is sent to a terminal device, where the configuration information is configured for configuring the one or more PSFCHs for each resource pool with the actual transmission powers corresponding to each resource pool.

In the embodiment of the present disclosure, the step 404 may be respectively implemented in any manner in various embodiments of the present disclosure, which is not limited in this embodiment of the present disclosure, and will not be repeated.

In the embodiment of the present disclosure, for each resource pool, a smaller power may be determined from the power control powers and the first maximum powers as the first candidate powers of the PSFCHs for each resource pool, the actual transmission power of each of the PSFCHs for each resource pool is determined according to the second maximum power and the first candidate power of each of the PSFCHs for each resource pool, and the configuration information is sent to the terminal device to configure the PSFCHs for each resource pool with the transmission powers corresponding to each resource pool. Therefore, for each resource pool, the actual transmission powers of the PSFCHs for each resource pool are determined based on the smaller power between the power control powers and the first maximum powers of the PSFCHs and the second maximum power supported by the terminal device, which may ensure the rationality of the configuration of the transmission powers of the PSFCHs and may solve the problem of the confusion in the power configuration of the terminal device.

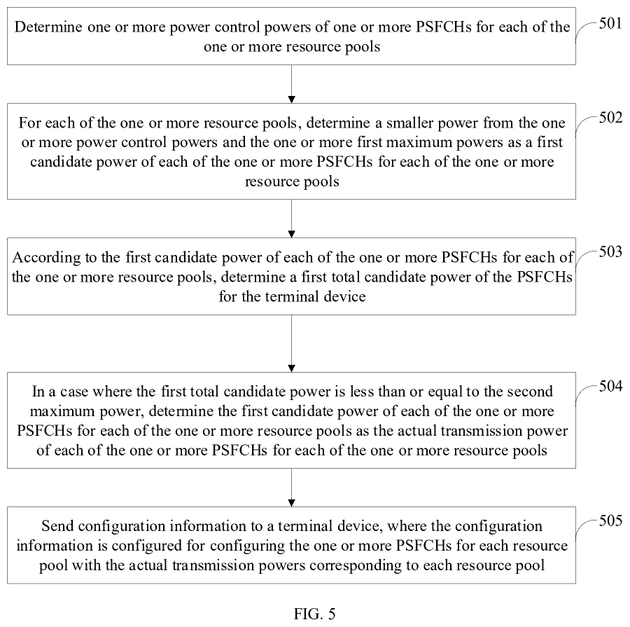

Referring FIG. 5, FIG. 5 is a schematic flowchart of another PSFCH transmission power configuration method provided by an embodiment of the present disclosure. The method is performed by a network device. As shown in FIG. 5, the method may include but is not limited to the following steps 501-505.

At step 501, one or more power control powers of one or more PSFCHs for each of the one or more resource pools are determined.

At step 502, for each of the one or more resource pools, a smaller power from the one or more power control powers and the one or more first maximum powers is determined as a first candidate power of each of the one or more PSFCHs for each of the one or more resource pools.

In the embodiment of the present disclosure, the steps 501-502 may be respectively implemented in any manner in various embodiments of the present disclosure, which is not limited in this embodiment of the present disclosure, and will not be repeated.

At step 503, according to the first candidate power of each of the one or more PSFCHs for each of the one or more resource pools, a first total candidate power of the PSFCHs for the terminal device is determined.

In the present disclosure, the network device may multiply the number of the PSFCHs for each resource pool by the first candidate power of each of the PSFCHs for each resource pool to obtain the first subpower of the PSFCHs for each resource pool, add the first subpowers of the PSFCHs for all the resource pools to obtain a sum of the first subpowers of the PSFCHs for all the resource pools, and determine the sum of the first subpowers of the PSFCHs for all the resource pools as the first total candidate power of the PSFCHs for the terminal device.

Based on the example in the embodiment, a method of calculating the first total candidate power may refer to the following Formulas (3) and (4):

$${P}_{{R}_{i}} = {PSFCH}_{{R}_{i}} * {K}_{i} ; \qquad ( 3 )$$

$${PSFCHR}_{all} = {\sum }_{i = 1}^{T} {P}_{{R}_{i}} . \qquad ( 4 )$$

In Formulas (3) and (4) P_{R}_{ᵢ} represents the first subpower for the resource pool Ri, and PSFCHRₐₗₗ represents the first total candidate power of the PSFCHs for the terminal device.

At step 504, in a case where the first total candidate power is less than or equal to the second maximum power, the first candidate power of each of the one or more PSFCHs for each of the one or more resource pools is determined as the actual transmission power of each of the one or more PSFCHs for each of the one or more resource pools.

In the present disclosure, the network device may compare the first total candidate power with the second maximum power, and if the first total candidate power is less than or equal to the second maximum power, it indicates that the maximum power of the PSFCHs supported by the terminal device may meet the transmission requirement of the PSFCHs for the resource pool, the first candidate powers of the PSFCHs for each resource pool may be determined as the actual transmission powers of the PSFCHs for each resource pool.

Based on the example, assuming that the second maximum power is represented by PCMAX PSFCHRₐₗₗ may be compared with P_{CMAX}, and if the following Formula (5) is met, the first candidate powers PSFCH_{R}_{ᵢ} for the resource pool Ri may be taken as the actual transmission powers of the PSFCHs for the resource pool Ri.

$${PSFCHR}_{all} \leq {P}_{CMAX} . \qquad ( 5 )$$

At step 505, configuration information is sent to a terminal device, where the configuration information is configured for configuring the one or more PSFCHs for each resource pool with the actual transmission powers corresponding to each resource pool.

In the embodiment of the present disclosure, the step 505 may be respectively implemented in any manner in various embodiments of the present disclosure, which is not limited in this embodiment of the present disclosure, and will not be repeated.

In the embodiment of the present disclosure, the first total candidate power of the PSFCHs for the terminal device may be determined according to the first candidate power of each of the PSFCHs for each resource pool. If the first total candidate power is less than or equal to the second maximum power, the first candidate powers of the PSFCHs for each resource pool are determined as the actual transmission powers of the PSFCHs for each resource pool, and the configuration information is sent to the terminal device, to configure the PSFCHs for each resource pool with the actual transmission powers corresponding to each resource pool. Therefore, in a case where the total candidate power of the PSFCHs for all the resource pools is less than or equal to the maximum power of the PSFCHs supported by the terminal device, the first candidate powers of the PSFCHs for each resource pool may be determined as the actual transmission powers of the PSFCHs for each resource pool, which may thereby solve the problem of the confusion in the power configuration of the terminal device.

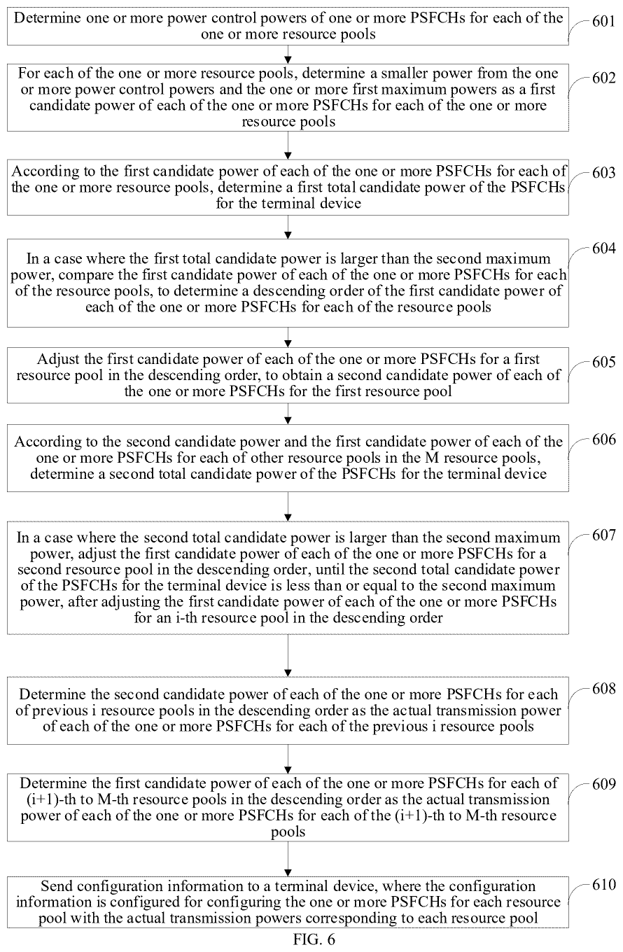

Referring FIG. 6, FIG. 6 is a schematic flowchart of another PSFCH transmission power configuration method provided by an embodiment of the present disclosure. The method is performed by a network device. As shown in FIG. 6, the method may include but is not limited to the following steps 601-610.

At step 601, one or more power control powers of one or more PSFCHs for each of the one or more resource pools are determined.

At step 602, for each of the one or more resource pools, a smaller power from the one or more power control powers and the one or more first maximum powers is determined as a first candidate power of each of the one or more PSFCHs for each of the one or more resource pools.

At step 603, according to the first candidate power of each of the one or more PSFCHs for each of the one or more resource pools, a first total candidate power of the PSFCHs for the terminal device is determined.

In the embodiment of the present disclosure, the steps 601-603 may be respectively implemented in any manner in various embodiments of the present disclosure, which is not limited in this embodiment of the present disclosure, and will not be repeated.

At step 604, in a case where the first total candidate power is larger than the second maximum power, the first candidate power of each of the one or more PSFCHs for each of the resource pools is compared, to determine a descending order of the first candidate power of each of the one or more PSFCHs for each of the resource pools.

In the present disclosure, if the first total candidate power is larger than the second maximum power, it indicates that the maximum power of the PSFCHs supported by the terminal device cannot meet the requirement of the first candidate powers of the PSFCHs for each resource pool, and then the first candidate powers of the PSFCHs for each of the resource pools may be compared, to determine a descending (from-large-to-small) order of the first candidate power of each of the PSFCHs for each of the resource pools.

At step 605, the first candidate power of each of the one or more PSFCHs for a first resource pool in the descending order is adjusted, to obtain a second candidate power of each of the one or more PSFCHs for the first resource pool.

In the present disclosure, the number of various resource pools is M, that is, the number of the resource pools corresponding to the PSFCHs is M, where M is a positive integer.

In the present disclosure, the first resource pool in the descending order is a resource pool with the highest first candidate power in the M resource pools.

In the present disclosure, the first candidate powers of the PSFCHs for the resource pool with the highest first candidate power may be first reduced, to obtain the second candidate powers corresponding to the resource pool.

In the present disclosure, the corresponding adjustment values are preset for each resource pool according to the descending order of the first candidate powers. The larger the first candidate power is, the larger the adjustment value is, and the network device may reduce the first candidate powers of the PSFCHs for the resource pool according to the adjustment value corresponding to the first resource pool in the descending order.

Optionally, the network device may reduce the first candidate powers of the PSFCHs for the first resource pool in the descending order to a target value.

For example, based on the example in the embodiment, the first candidate powers of the PSFCHs for the first resource pool in the descending order may be reduced to a target value P_{CMAX}−10 log₁₀ N.

Optionally, the network device may alternatively reduce the first candidate powers of the PSFCHs for the first resource pool in the descending order to a certain value larger than the target value P_{CMAX}−10 log₁₀ N, and then calculate the total candidate power of the PSFCHs for the terminal device based on the Formulas (3) and (4). If the total candidate power of the PSFCHs for the terminal device is still larger than the second maximum power, the network device continues to reduce the value until the value is adjusted to the target value.

At step 606, according to the second candidate power and the first candidate power of each of the one or more PSFCHs for each of other resource pools in the M resource pools, a second total candidate power of the PSFCHs for the terminal device is determined.

In the present disclosure, the network device may multiply the second candidate power by the number of PSFCHs for the first resource pool in the descending order, to obtain a second subpower of the PSFCHs for the resource pool, and for the other resource pools in the M resource pools except the resource pool with the highest first candidate power, obtain the first subpower according to a product of the number of the PSFCHs for each of the other resource pools and the first candidate power, and add the second subpower to the first subpower of the PSFCHs of each of the other resource pools, to obtain the second total candidate power of the PSFCHs for the terminal device.

In other words, after the first candidate powers of the PSFCHs for the first resource pool in the descending order are reduced to the second candidate powers, the second total candidate power of the PSFCHs for the terminal device may be calculated by the Formulas (3) and (4).

At step 607, in a case where the second total candidate power is larger than the second maximum power, the first candidate power of each of the one or more PSFCHs for a second resource pool in the descending order is adjusted, until the second total candidate power of the PSFCHs for the terminal device is less than or equal to the second maximum power, after adjusting the first candidate power of each of the one or more PSFCHs for an i-th resource pool in the descending order.

The second resource pool in the descending order is a resource pool with the second-highest first candidate power in the M resource pools.

In the present disclosure, after the first candidate powers corresponding to the resource pool with the highest first candidate power are adjusted, if the second total candidate power of the PSFCHs for the terminal device is larger than the second maximum power, the first candidate powers of the PSFCHs for the second resource pool in the descending order may be reduced, and the second total candidate power of the PSFCHs for the terminal device is calculated; if the second total candidate power of the PSFCHs for the terminal device is still larger than the second maximum power, the first candidate powers of the PSFCHs for the third resource pool in the descending order may be continuously reduced, until the second total candidate power of the PSFCHs for the terminal device is less than or equal to the second maximum power, after reducing the first candidate powers of the PSFCHs for the i-th resource pool in the descending order.

i may be a positive integer less than or equal to M.

In the present disclosure, the manner of adjusting the first candidate powers of the PSFCHs for each of the other resource pools is similar to the manner of adjusting the first candidate powers of the PSFCHs for the first resource pool in the descending order, and therefore will be not described herein again.

At step 608, the second candidate power of each of the one or more PSFCHs for each of previous i resource pools in the descending order is determined as the actual transmission power of each of the one or more PSFCHs for each of the previous i resource pools.

In the present disclosure, the obtained second candidate powers for each of previous i resource pools in the descending order after the adjustment are determined as the actual transmission powers of the PSFCHs for each of the previous i resource pools.

For example, Mis 4, i is 2, the resource pool with the highest first candidate power may be adjusted to obtain the second candidate powers as the actual transmission powers of the PSFCHs for the resource pool with the highest first candidate power, and the resource pool with the second-highest first candidate power may be adjusted to obtain the second candidate powers as the actual transmission powers of the PSFCHs for the resource pool with the second-highest first candidate power.

At step 609, the first candidate power of each of the one or more PSFCHs for each of (i+1)-th to M-th resource pools in the descending order is determined as the actual transmission power of each of the one or more PSFCHs for each of the (i+1)-th to M-th resource pools.

In the present disclosure, the first candidate power of each of the PSFCHs for each of the (i+1)-th to M-th resource pools in the descending order is not adjusted, the first candidate power of each of the PSFCHs for each of the (i+1)-th to M-th resource pools in the descending order may be determined as the actual transmission power of each of the PSFCHs for each of the (i+1)-th to M-th resource pools.

At step 610, configuration information is sent to a terminal device, where the configuration information is configured for configuring the one or more PSFCHs for each resource pool with the actual transmission powers corresponding to each resource pool.

In the embodiment of the present disclosure, the step 610 may be respectively implemented in any manner in various embodiments of the present disclosure, which is not limited in this embodiment of the present disclosure, and will not be repeated.

In the embodiment of the present disclosure, the number of various resource pools is M, and if the first total candidate power is larger than the second maximum power, the first candidate power of each of the PSFCHs for each of the resource pools may be adjusted in the descending order of the first candidate powers, until the second total candidate power of the PSFCHs for the terminal device is less than or equal to the second maximum power, after adjusting the first candidate power of each of the PSFCHs for the i-th resource pool in the descending order; for the resource pools for which the first candidate powers are adjusted, the second candidate powers obtained after the adjustment may be taken as the actual transmission powers of the PSFCHs for each of the resource pools; and for the resource pools for which the first candidate powers are not adjusted, the first candidate power may be taken as the actual transmission power of each of the PSFCHs for each of the resource pools, which may thereby solve the problem of the confusion in the power configuration of the terminal device.

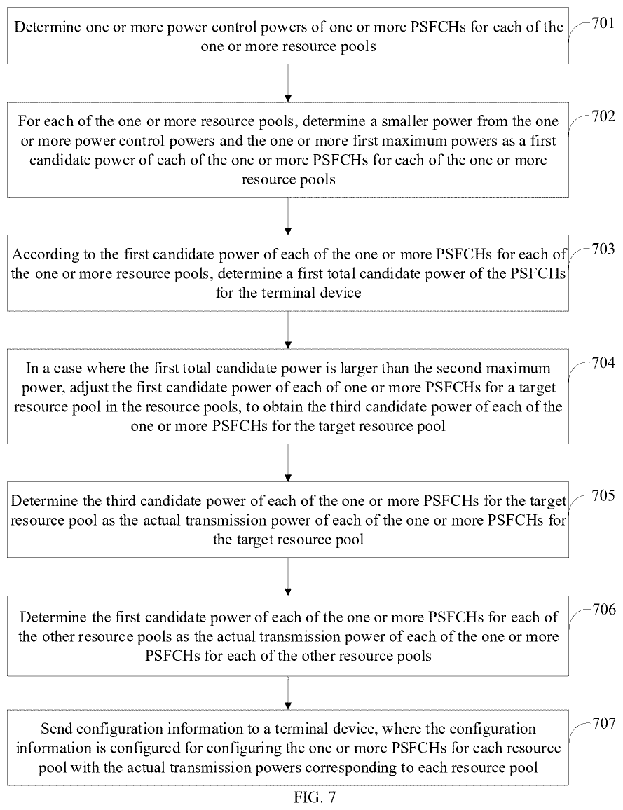

Referring FIG. 7, FIG. 7 is a schematic flowchart of another PSFCH transmission power configuration method provided by an embodiment of the present disclosure. The method is performed by a network device. As shown in FIG. 7, the method may include but is not limited to the following steps 701-707.

At step 701, one or more power control powers of one or more PSFCHs for each of the one or more resource pools are determined.

At step 702, for each of the one or more resource pools, a smaller power from the one or more power control powers and the one or more first maximum powers is determined as a first candidate power of each of the one or more PSFCHs for each of the one or more resource pools.

At step 703, according to the first candidate power of each of the one or more PSFCHs for each of the one or more resource pools, a first total candidate power of the PSFCHs for the terminal device is determined.

In the embodiment of the present disclosure, the steps 701-703 may be respectively implemented in any manner in various embodiments of the present disclosure, which is not limited in this embodiment of the present disclosure, and will not be repeated.

At step 704, in a case where the first total candidate power is larger than the second maximum power, the first candidate power of each of one or more PSFCHs for a target resource pool in the resource pools is adjusted, to obtain the third candidate power of each of the one or more PSFCHs for the target resource pool.

In the present disclosure, if the first total candidate power is larger than the second maximum power, the first candidate powers of PSFCHs for the target resource pool in the resource pools may be reduced to the third candidate powers, so that the third total candidate power of the PSFCHs for the terminal device is less than or equal to the second maximum power.

The third total candidate power may be determined based on the third candidate powers and a first candidate powers of the PSFCHs for each of the other resource pools in the resource pools, and the manner of calculating the third total candidate power is similar to the described manner of calculating the first total candidate power, and then will not be repeated here.

In the present disclosure, one or more target resource pools may be one or more of the resource pools, which is not limited in the present disclosure.

Optionally, if the first total candidate power is larger than the second maximum power, one or more resource pools may be randomly selected from the various resource pools as the one or more target resources, and the first candidate powers of PSFCHs for each of the one or more target resources are reduced, to obtain the third candidate powers of the PSFCHs for each of the one or more target resources.

Optionally, if the first total candidate power is larger than the second maximum power, previous one or more resource pools with the highest first candidate power in the resource pools may also be taken as the one or more target resource pools, and the first candidate powers of the PSFCHs for each of the one or more target resources will be reduced, to obtain the third candidate powers of the PSFCHs for each of the one or more target resource pools.

At step 705, the third candidate power of each of the one or more PSFCHs for the target resource pool is determined as the actual transmission power of each of the one or more PSFCHs for the target resource pool.

In the present disclosure, for the target resource pool, the third candidate powers obtained after adjusting the first candidate powers of the PSFCHs for the target resource pool may be taken as the actual transmission powers of the PSFCHs for the target resource pool.

At step 706, the first candidate power of each of the one or more PSFCHs for each of the other resource pools is determined as the actual transmission power of each of the one or more PSFCHs for each of the other resource pools.

In the present disclosure, for the other resource pools in various resource pools except the target resource pool, the first candidate powers of the PSFCHs for each of the other resource pools may be taken as the actual transmission powers of the PSFCHs for each of the other resource pools.

At step 707, configuration information is sent to a terminal device, where the configuration information is configured for configuring the one or more PSFCHs for each resource pool with the actual transmission powers corresponding to each resource pool.

In the embodiment of the present disclosure, the step 707 may be respectively implemented in any manner in various embodiments of the present disclosure, which is not limited in this embodiment of the present disclosure, and will not be repeated.

In the embodiment of the present disclosure, if the first total candidate power is larger than the second maximum power, the first candidate power of each of the PSFCHs for a target resource pool in the resource pools may be adjusted, to obtain a third candidate power of each of the PSFCHs for the target resource pool; where a third total candidate power of the PSFCHs for the terminal device is less than or equal to the second maximum power, and the third total candidate power is determined based on the third candidate power of each of the PSFCHs for the target resource pool and the first candidate power of each of the PSFCHs for each of the other resource pools in the various resource pools; the third candidate power of each of the PSFCHs for the target resource pool is determined as the actual transmission power of each of the PSFCHs for the target resource pool; and the first candidate power of each of the PSFCHs for each of the other resource pools is determined as the actual transmission power of each of the PSFCHs for each of the other resource pools, which may thereby solve the problem of the confusion in the power configuration of the terminal device.

For ease of understanding the PSFCH transmission power configuration method of the present disclosure, description is carried out through the following embodiments below.

The network device may configure the time-frequency resource for the PSFCHs for the terminal device in the sidelink transmission. For example, there are a total of N PSFCHs transmitting simultaneously in a PSFCH transmission moment, that is, a sidelink frame including the PSFCHs, where the N PSFCHs correspond to a total of R resource pools, and the resource pool Ri correspond to Ki PSFCHs transmitting, which meets

$$N = {\sum }_{i = 1}^{T} {K}_{i} .$$

The network device may calculate the power control power P_{PSFCH,one} according to the Formula (1), and take PSFCH_{R}_{ᵢ} as a smaller value between the first power and P_{PSFCH,one} that is, the Formula (2).

The network device may further receive the maximum power P_{CMAX} of the PSFCHs that is reported by the terminal device and is supported by the terminal device, and the network device may ensure that a sum of configured powers of PSFCHs for each resource pool is less than P_{CMAX}, that is, meets the Formula (5).

If the sum

$${\sum }_{i = 1}^{R} ( {PSFCH}_{{R}_{i}} * {K}_{i} )$$

of the configured powers of the PSFCHs for each resource pool calculated by the network device is larger than P_{CMAX}, powers of all PSFCHs for the resource pool with the highest PSFCHR_{R}_{ᵢ} may be firstly reduced until corresponding PSFCHR_{R}_{ᵢ}=P_{CMAX}−10 log₁₀ N If the Formula (5) is not still met at this time, the powers of the PSFCHs for the resource pool with the second-highest PSFCHR_{R}_{ᵢ} may continue to be reduced until corresponding PSFCHR_{R}_{ᵢ}=P_{CMAX}−10 log₁₀ N, and so on, so that the network device completes configuration for the powers of the PSFCHs. The network device may configure the determined actual transmission powers of the PSFCHs to the terminal device, where the network device may configure a same actual transmission power for PSFCHs belonging to a same resource pool. The terminal device may correspondingly transmit data through the PSFCHs according to the configuration of the actual transmission powers of the PSFCHs sent by the network device.

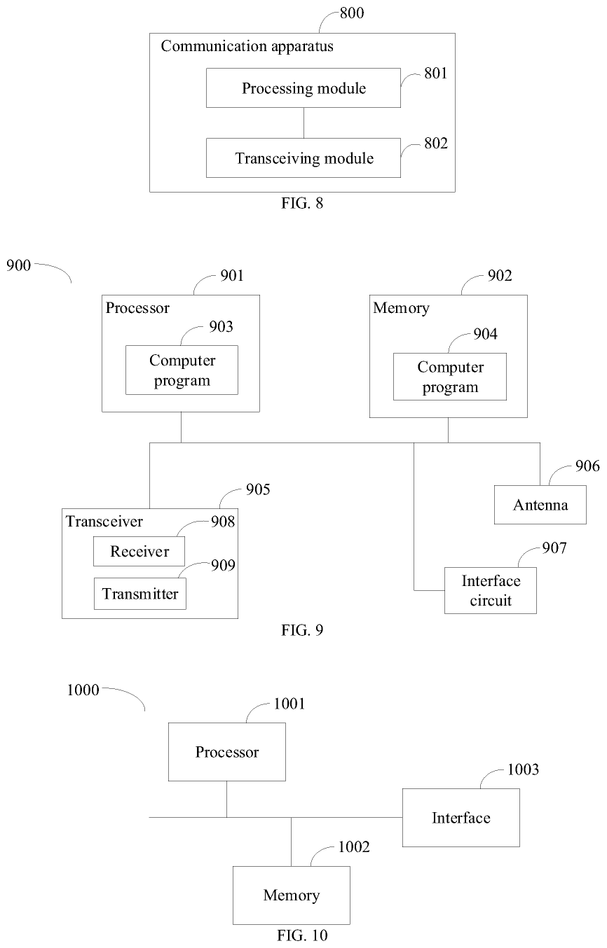

Referring to FIG. 8, FIG. 8 is a schematic structural diagram of a communication apparatus provided by an embodiment of the present disclosure. The communication apparatus 800 shown in FIG. 8 may include a processing module 801 and a transceiving module 802. The transceiving module 802 may include a transmitting module and/or a receiving module. The transmitting module is configured to implement a transmitting function, the receiving module is configured to implement a receiving function, and the transceiving module 802 may implement the transmitting function and/or the receiving function.

It may be understood that the communication apparatus 800 may be a network device, may be an apparatus in the network device, or may be an apparatus that can be matched with the network device for use.

The communication apparatus 800 is on a network device side.

The processing module 801 is configured to determine actual transmission powers of PSFCHs according to a transmission time-frequency resource actually configured for the PSFCHs and one or more resource pools corresponding to the PSFCHs.

The transceiving module 802 is configured to send configuration information to a terminal device, where the configuration information is configured for configuring the actual transmission powers of the PSFCHs.

Optionally, the processing module 801 is configured to: determine one or more power control powers of one or more PSFCHs for each of the one or more resource pools; and determine an actual transmission power of each of the one or more PSFCHs for each of the one or more resource pools, according to the one or more power control powers, one or more first maximum powers of the one or more PSFCHs for each of the one or more resource pools, and a second maximum power of the PSFCHs supported by the terminal device.

Optionally, the processing module 801 is configured to: for each of the one or more resource pools, determine a smaller power from the one or more power control powers and the one or more first maximum powers as a first candidate power of each of the one or more PSFCHs for each of the one or more resource pools; and determine, according to the second maximum power and the first candidate power of each of the one or more PSFCHs for each of the one or more resource pools, the actual transmission power of each of the one or more PSFCHs for each of the one or more resource pools.

Optionally, the processing module 801 is configured to: determine, according to the first candidate power of each of the one or more PSFCHs for each of the one or more resource pools, a first total candidate power of the PSFCHs for the terminal device; and in a case where the first total candidate power is less than or equal to the second maximum power, determine the first candidate power of each of the one or more PSFCHs for each of the one or more resource pools as the actual transmission power of each of the one or more PSFCHs for each of the one or more resource pools.

Optionally, the processing module 801 is configured to: determine a first subpower of the one or more PSFCHs for each of the one or more resource pools, according to the number of the one or more PSFCHs for each of the one or more resource pools and the first candidate power of each of the one or more PSFCHs for each of the one or more resource pools; and determine a sum of first subpowers of the PSFCHs for the one or more resource pools as the first total candidate power.

Optionally, the processing module 801 is configured to: in a case where the first total candidate power is larger than the second maximum power, compare the first candidate power of each of the one or more PSFCHs for each of the resource pools, to determine a descending order of the first candidate power of each of the one or more PSFCHs for each of the resource pools; adjust the first candidate power of each of the one or more PSFCHs for a first resource pool in the descending order, to obtain a second candidate power of each of the one or more PSFCHs for the first resource pool; determine, according to the second candidate power and the first candidate power of each of the one or more PSFCHs for each of other resource pools in the M resource pools, a second total candidate power of the PSFCHs for the terminal device. And in a case where the second total candidate power is larger than the second maximum power, adjust the first candidate power of each of the one or more PSFCHs for a second resource pool in the descending order, until the second total candidate power of the PSFCHs for the terminal device is less than or equal to the second maximum power, after adjusting the first candidate power of each of the one or more PSFCHs for an i-th resource pool in the descending order, where i is a positive integer less than or equal to M; determine the second candidate power of each of the one or more PSFCHs for each of previous i resource pools in the descending order as the actual transmission power of each of the one or more PSFCHs for each of the previous i resource pools; and determine the first candidate power of each of the one or more PSFCHs for each of (i+1)-th to M-th resource pools in the descending order as the actual transmission power of each of the one or more PSFCHs for each of the (i+1)-th to M-th resource pools.

Optionally, the processing module 801 is configured to: in a case where the first total candidate power is larger than the second maximum power, adjust the first candidate power of each of the one or more PSFCHs for a target resource pool in the resource pools, to obtain a third candidate power of each of the one or more PSFCHs for the target resource pool; where a third total candidate power of the PSFCHs for the terminal device is less than or equal to the second maximum power, and the third total candidate power is determined based on the third candidate power and the first candidate power of each of the one or more PSFCHs for each of other resource pools in the resource pools; determine the third candidate power of each of the one or more PSFCHs for the target resource pool as the actual transmission power of each of the one or more PSFCHs for the target resource pool; and determine the first candidate power of each of the one or more PSFCHs for each of the other resource pools as the actual transmission power of each of the one or more PSFCHs for each of the other resource pools.

Optionally, the processing module 801 is configured to: obtain an initial power, a compensation coefficient, and a downlink path loss reported by the terminal device; and determine the one or more power control powers according to the initial power, the compensation coefficient, and the downlink path loss.

In the present disclosure, the network device may determine the actual transmission powers of the PSFCHs according to the transmission time-frequency resource actually configured for the PSFCHs and the resource pools corresponding to the PSFCHs, to configure the actual transmission powers for the PSFCHs, which, compared with configuring the power control power for each PSFCH for the terminal device, may ensure the rationality of the configuration of the transmission powers of the PSFCHs and thus may solve the problem of the confusion in the power configuration of the terminal device.

Referring to FIG. 9, FIG. 9 is a schematic structural diagram of another communication apparatus provided by an embodiment of the present disclosure. In FIG. 9, the communication apparatus 900 may be a network device or a terminal device; the communication apparatus 1000 may also be a chip, a chip system, or a processor that supports the network device to implement any of the methods, etc.; the communication apparatus 900 may also be a chip, a chip system, or a processor that supports the terminal device to implement the any of the methods. This apparatus may be configured to implement the method described in any of the method embodiments, which may specifically refer to the description in any of the method embodiments.

The communication apparatus 900 may include one or more processors 901. The processors 901 may be general-purpose processors, special-purpose processors, etc. For example, the processors 901 may be baseband processors or central processing units. The baseband processor may be configured for processing a communication protocol and communication data, and the central processing unit may be configured for controlling the communication apparatus (for example, a base station, a baseband chip, a terminal device, a terminal device chip, a DU, a CU, etc.), executing a computer program, and processing data of the computer program.

Optionally, the communication apparatus 900 may further include one or more memories 902 that may store a computer program 904, and the processors 901 execute the computer program 904 to cause the communication apparatus 900 to perform the method described in any of the method embodiments. Optionally, the memories 902 may further store data. The communication apparatus 900 and the memories 902 may be separately configured, or may be integrated together.

Optionally, the communication apparatus 900 may further include a transceiver 905 and an antenna 906. The transceiver 905 may be referred to as a transceiver unit, a transceiver machine, a transceiver circuit, etc., and is configured for implementing a transceiver function. The transceiver 905 may include a receiver 908 and a transmitter 909. The receiver 908 may be referred to as a receiving machine, a receiving circuit, etc., and is configured for implementing a receiving function. The transmitter 909 may be referred to as a transmitting machine, a transmitting circuit, etc., and is configured for implementing a transmitting function.

Optionally, the communication apparatus 900 may further include one or more interface circuits 907. The interface circuits 907 are configured for receiving code instructions and transmitting the code instructions to the processor 901. The processor 901 executes the code instructions to cause the communication apparatus 900 to perform the method described in any of the method embodiments.

The communication apparatus 900 is a network device, and the transceiver 905 is configured to perform the step 202 in FIG. 2, the step 303 in FIG. 3, the step 404 in FIG. 4, the step 505 in FIG. 5, the step 610 in FIG. 6, and the step 707 in FIG. 7.

In an implementation, the processor 901 may include a transceiver (not shown) for implementing the receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface, or the interface circuit may be used to read and write codes/data, or the transceiving circuit, the interface, or the interface circuit may be used to transmit or transfer a signal.

In an implementation, the processor 901 may store a computer program 903, and the computer program 903 is performed by the processor 901, so that the communication apparatus 900 may perform the method described in any of the method embodiments. The computer program 903 may be fixed in the processor 901, and in this situation, the processor 901 may be implemented by hardware.

In an implementation, the communication apparatus 900 may include a circuit, and the circuit may implement sending, receiving, or communicating functions in any of the method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver may also be fabricated with various IC process technologies, such as a complementary metal oxide semiconductor (CMOS), an n-metal oxide semiconductor (NMOS), a p-metal oxide semiconductor (positive channel metal oxide semiconductor, PMOS), a bipolar junction transistor (BJT), a bipolar CMOS (BiCMOS), a silicon germanium (SiGe), a gallium arsenide (GaAs), etc.

The communication apparatus described in the embodiments may be a network device or a terminal device, but a scope of the communication apparatus described in the present disclosure is not limited thereto, and a structure of the communication apparatus may not be limited by FIG. 9. The communication apparatus may be a separate device or may be a part of a larger device. For example, the communication apparatus may be: (1) a separate integrated circuit IC, chip, or chip system or subsystem; (2) a set of one or more ICs; optionally, the set of ICs may also include a storage component for storing data and a computer program; (3) an ASIC, for example, a modem; (4) a module that may be embedded within other devices; (5) a receiving machine, a terminal device, an intelligent terminal device, a cellular phone, a wireless device, a handset, a mobile unit, an in-vehicle device, a network device, a cloud device, an artificial intelligence device, etc.; or (6) other apparatus, etc.

The case in which the communication apparatus may be a chip or a chip system may refer to the schematic structural diagram of the chip shown in FIG. 10. The chip 1000 shown in FIG. 10 includes a processor 1001 and an interface 1003. There may be one or more processors 1001, and there may be multiple interfaces 1003.

For the case in which the chip is configured for implementing functions of the network device in the embodiments of the present disclosure. The interface 1003 is configured to perform the step 202 in FIG. 2, the step 303 in FIG. 3, the step 404 in FIG. 4, the step 505 in FIG. 5, the step 610 in FIG. 6, the step 707 in FIG. 7, etc.

Optionally, the chip 1000 further includes a memory 1002, and the memory 1002 is configured for storing a necessary computer program and data.

Those skilled in the art may also understand that various illustrative logical blocks and steps listed in the embodiments of the present disclosure may be implemented by using electronic hardware, computer software, or a combination of the two. Whether such function is implemented by hardware or software depends on specific applications and design requirements of an overall system. Those skilled in the art may use various methods to implement the functions for each specific application, but this implementation should not be understood as going beyond the protection scope of the embodiments of the present disclosure.

The present disclosure further provides a non-transitory computer-readable storage medium that stories instructions. When the instructions are executed by a computer, functions of any one of the method embodiments are implemented.

The present disclosure further provides a computer program product. When the computer program product is executed by a computer, the functions of any one of the method embodiments are implemented.

In the embodiments, it may be implemented in whole or in part by software, hardware, firmware, or any combination thereof. When implemented in software, it may be implemented in whole or in part in the form of a computer program product. The computer program product includes one or more computer programs. When the computer programs are loaded and executed by a computer, the processes or functions according to embodiments of the present disclosure are generated in whole or in part. The computer may be a general purpose computer, a special purpose computer, a computer network, or other programmable apparatus. The computer programs may be stored in a computer readable storage medium or transmitted from one computer readable storage medium to another computer readable storage medium. For example, the computer programs may be transmitted from a website site, computer, server or data center to another website site, computer, server or data center by a wired (for example, a coaxial-cable, a fiber, a digital subscriber line (DSL)) or wirelessly (for example, infrared, wireless, microwave, etc.) manner. The computer readable storage medium may be any available medium that can be accessed by a computer or may be a data storage device, such as a server, data center, or the like, including one or more integrated available mediums. The available medium may be a magnetic medium (for example, a floppy disk, a hard disk, a magnetic tape), an optical medium (for example, a high density digital video disc (DVD)), or a semiconductor medium (for example, a solid state disk (SSD)), etc.

A fourth aspect of the embodiments of the present disclosure provides a communication apparatus, including: a processing module, configured to determine actual transmission powers of PSFCHs according to a transmission time-frequency resource actually configured for the PSFCHs and one or more resource pools corresponding to the PSFCHs; and a transceiving module, configured to send configuration information to a terminal device, where the configuration information is configured for configuring the actual transmission powers of the PSFCHs.

A fifth aspect of the embodiments of the present disclosure provides a communication apparatus. The communication apparatus includes a processor and a memory, the memory stores a computer program, and the processor executes the computer program stored in the memory, to cause the communication apparatus to perform the method in the first aspect.

A sixth aspect of the embodiments of the present disclosure provides another communication apparatus. The apparatus includes a processor and an interface circuit; the interface circuit is configured to receive code instructions and transmitting the code instructions to the processor, and the processor is configured to execute the code instructions to cause the apparatus to perform the method in the first aspect.

A seventh aspect of the embodiments of the present disclosure further provides a computer program product including a computer program. When the computer program is executed by a computer, the computer performs the method in the first aspect.

An eighth aspect of the embodiments of the present disclosure provides a chip system. The chip system includes at least one processor and an interface, and is configured to support the terminal in implementing the functions involved in the first aspect, for example, determining or processing at least one of data and information involved in any of the methods. In a possible design, the chip system further includes a memory, and the memory is configured to store a computer program and data that are necessary for the communication apparatus. The chip system may be composed of a chip, or may include a chip and other discrete components.

A ninth aspect of the embodiments of the present disclosure further provides a computer program. When the computer program is executed by a computer, the computer performs the method in the first aspect.

Those skilled in the art may understand that various numerical numbers such as “first” and “second” involved in the present disclosure are only for distinguishing for the convenience of description and are not intended to limit the scope of the embodiments of the present disclosure, and do not also represent an early-later sequence.

“At least one” in the present disclosure may also be described as one or more, and “a plurality of/multiple” may be two, three, four or more, which is not limited in the present disclosure. In the embodiments of the present disclosure, for a kind of technical features, technical features in the kind of technical features are distinguished by “first”, “second”, “third”, “A”, “B”, “C”, and “D”, etc., and there is no an early-later sequence or a large-small sequence among the technical features described by “first”, “second”, “third”, “A”, “B”, “C”, and “D”.

The correspondence relationships shown in each table in the present disclosure may be configured or predefined. Values of the information in each table are merely examples, and may be configured as other values, which is not limited in the present disclosure. When configuring correspondence relationships between the information and each parameter, it is not necessarily required to configure all the correspondence relationships shown in each table. For example, correspondence relationships shown in certain rows may also not be configured in the tables in the present disclosure. For another example, appropriate deformation adjustment may be performed based on the above tables, for example, splitting, merging, etc. A name of a parameter shown by a title in each of the above tables may also be another name that may be understood by the communication apparatus, and a value or a representation manner of the parameter may also be another value or representation manner that may be understood by the communication apparatus. During implementation of each of the above tables, other data structures may also be used, for example, an array, a queue, a container, a stack, a linear table, a pointer, a linked list, a tree, a graph, a structure body, a class, a heap, a hashing table or a hash table, etc., may be used.

1. A physical sidelink feedback channel (PSFCH) transmission power configuration method, performed by a network device and comprising:
determining actual transmission powers of PSFCHs according to a transmission time-frequency resource actually configured for the PSFCHs and one or more resource pools corresponding to the PSFCHs; and
sending configuration information to a terminal device, wherein the configuration information is configured for configuring the actual transmission powers of the PSFCHs.

2. The method of claim 1, wherein the determining actual transmission powers of PSFCHs according to a transmission time-frequency resource actually configured for the PSFCHs and one or more resource pools corresponding to the PSFCHs, comprises:
determining one or more power control powers of one or more PSFCHs for each of the one or more resource pools; and
determining the actual transmission power of each of the one or more PSFCHs for each of the one or more resource pools, according to the one or more power control powers, one or more first maximum powers of the one or more PSFCHs for each of the one or more resource pools, and a second maximum power of the PSFCHs supported by the terminal device.

3. The method of claim 2, wherein the determining the actual transmission power of each of the one or more PSFCHs for each of the one or more resource pools, according to the one or more power control powers, one or more first maximum powers of the one or more PSFCHs for each of the one or more resource pools, and a second maximum power of the PSFCHs supported by the terminal device, comprises:
for each of the one or more resource pools, determining a smaller power from the one or more power control powers and the one or more first maximum powers as a first candidate power of each of the one or more PSFCHs for each of the one or more resource pools; and
determining, according to the second maximum power and the first candidate power of each of the one or more PSFCHs for each of the one or more resource pools, the actual transmission power of each of the one or more PSFCHs for each of the one or more resource pools.

4. The method of claim 3, wherein the determining, according to the second maximum power and the first candidate power of each of the one or more PSFCHs for each of the one or more resource pools, the actual transmission power of each of the one or more PSFCHs for each of the one or more resource pools, comprises:
determining, according to the first candidate power of each of the one or more PSFCHs for each of the one or more resource pools, a first total candidate power of the PSFCHs for the terminal device; and
determining, in a case where the first total candidate power is less than or equal to the second maximum power, the first candidate power of each of the one or more PSFCHs for each of the one or more resource pools as the actual transmission power of each of the one or more PSFCHs for each of the one or more resource pools.

5. The method of claim 4, wherein the determining, according to the first candidate power of each of the one or more PSFCHs for each of the one or more resource pools, a first total candidate power of the PSFCHs for the terminal device, comprises:
determining a first subpower of the one or more PSFCHs for each of the one or more resource pools, according to a number of the one or more PSFCHs for each of the one or more resource pools and the first candidate power of each of the one or more PSFCHs for each of the one or more resource pools; and
determining a sum of first subpowers of the PSFCHs for the one or more resource pools as the first total candidate power.

6. The method of claim 4, wherein a number of the resource pools is M, and M is a positive integer, and the method further comprises:
comparing, in a case where the first total candidate power is larger than the second maximum power, the first candidate power of each of the one or more PSFCHs for each of the resource pools, to determine a descending order of the first candidate power of each of the one or more PSFCHs for each of the resource pools;
adjusting the first candidate power of each of the one or more PSFCHs for a first resource pool in the descending order, to obtain a second candidate power of each of the one or more PSFCHs for the first resource pool;
determining, according to the second candidate power and the first candidate power of each of the one or more PSFCHs for each of other resource pools in the M resource pools, a second total candidate power of the PSFCHs for the terminal device;
adjusting, in a case where the second total candidate power is larger than the second maximum power, the first candidate power of each of the one or more PSFCHs for a second resource pool in the descending order, until, after adjusting the first candidate power of each of the one or more PSFCHs for an i-th resource pool in the descending order, the second total candidate power of the PSFCHs for the terminal device is less than or equal to the second maximum power, where i is a positive integer less than or equal to M;
determining the second candidate power of each of the one or more PSFCHs for each of previous i resource pools in the descending order as the actual transmission power of each of the one or more PSFCHs for each of the previous i resource pools; and
determining the first candidate power of each of the one or more PSFCHs for each of (i+1)-th to M-th resource pools in the descending order as the actual transmission power of each of the one or more PSFCHs for each of the (i+1)-th to M-th resource pools.

7. The method of claim 4, further comprising:
adjusting, in a case where the first total candidate power is larger than the second maximum power, the first candidate power of each of the one or more PSFCHs for a target resource pool in the resource pools, to obtain a third candidate power of each of the one or more PSFCHs for the target resource pool; wherein a third total candidate power of the PSFCHs for the terminal device is less than or equal to the second maximum power, and the third total candidate power is determined based on the third candidate power and the first candidate power of each of the one or more PSFCHs for each of other resource pools in the resource pools;
determining the third candidate power of each of the one or more PSFCHs for the target resource pool as the actual transmission power of each of the one or more PSFCHs for the target resource pool; and
determining the first candidate power of each of the one or more PSFCHs for each of the other resource pools as the actual transmission power of each of the one or more PSFCHs for each of the other resource pools.

8. The method of claim 2, wherein the determining one or more power control powers of one or more PSFCHs for each of the one or more resource pools, comprises:
obtaining an initial power, a compensation coefficient, and a downlink path loss reported by the terminal device; and
determining the one or more power control powers according to the initial power, the compensation coefficient, and the downlink path loss.

9. (canceled)

10. A communication apparatus, comprising a processor and a memory, wherein the memory stores a computer program, and the processor is configured, when executing the computer program stored in the memory, to:
determine actual transmission powers of physical sidelink feedback channels (PSFCHs) according to a transmission time-frequency resource actually configured for the PSFCHs and one or more resource pools corresponding to the PSFCHs; and
send configuration information to a terminal device, wherein the configuration information is configured for configuring the actual transmission powers of the PSFCHs.

11. A non-transitory computer-readable storage medium, configured to store instructions, wherein a computer is configured to execute the instructions, to:
determine actual transmission powers of physical sidelink feedback channels (PSFCHs) according to a transmission time-frequency resource actually configured for the PSFCHs and one or more resource pools corresponding to the PSFCHs; and
send configuration information to a terminal device, wherein the configuration information is configured for configuring the actual transmission powers of the PSFCHs.

12. The communication apparatus of claim 10, wherein the processor is specifically configured to:
determine one or more power control powers of one or more PSFCHs for each of the one or more resource pools; and
determine the actual transmission power of each of the one or more PSFCHs for each of the one or more resource pools, according to the one or more power control powers, one or more first maximum powers of the one or more PSFCHs for each of the one or more resource pools, and a second maximum power of the PSFCHs supported by the terminal device.

13. The communication apparatus of claim 12, wherein the processor is specifically configured to:
for each of the one or more resource pools, determine a smaller power from the one or more power control powers and the one or more first maximum powers as a first candidate power of each of the one or more PSFCHs for each of the one or more resource pools; and
determine, according to the second maximum power and the first candidate power of each of the one or more PSFCHs for each of the one or more resource pools, the actual transmission power of each of the one or more PSFCHs for each of the one or more resource pools.

14. The communication apparatus of claim 13, wherein the processor is specifically configured to:
determine, according to the first candidate power of each of the one or more PSFCHs for each of the one or more resource pools, a first total candidate power of the PSFCHs for the terminal device; and
determine, in a case where the first total candidate power is less than or equal to the second maximum power, the first candidate power of each of the one or more PSFCHs for each of the one or more resource pools as the actual transmission power of each of the one or more PSFCHs for each of the one or more resource pools.

15. The communication apparatus of claim 14, wherein the processor is specifically configured to:
determine a first subpower of the one or more PSFCHs for each of the one or more resource pools, according to a number of the one or more PSFCHs for each of the one or more resource pools and the first candidate power of each of the one or more PSFCHs for each of the one or more resource pools; and
determine a sum of first subpowers of the PSFCHs for the one or more resource pools as the first total candidate power.

16. The communication apparatus of claim 14, wherein a number of the resource pools is M, and M is a positive integer, and the processor is further configured to:
compare, in a case where the first total candidate power is larger than the second maximum power, the first candidate power of each of the one or more PSFCHs for each of the resource pools, to determine a descending order of the first candidate power of each of the one or more PSFCHs for each of the resource pools;
adjust the first candidate power of each of the one or more PSFCHs for a first resource pool in the descending order, to obtain a second candidate power of each of the one or more PSFCHs for the first resource pool;
determine, according to the second candidate power and the first candidate power of each of the one or more PSFCHs for each of other resource pools in the M resource pools, a second total candidate power of the PSFCHs for the terminal device;
adjust, in a case where the second total candidate power is larger than the second maximum power, the first candidate power of each of the one or more PSFCHs for a second resource pool in the descending order, until, after adjusting the first candidate power of each of the one or more PSFCHs for an i-th resource pool in the descending order, the second total candidate power of the PSFCHs for the terminal device is less than or equal to the second maximum power, where i is a positive integer less than or equal to M;
determine the second candidate power of each of the one or more PSFCHs for each of previous i resource pools in the descending order as the actual transmission power of each of the one or more PSFCHs for each of the previous i resource pools; and
determine the first candidate power of each of the one or more PSFCHs for each of (i+1)-th to M-th resource pools in the descending order as the actual transmission power of each of the one or more PSFCHs for each of the (i+1)-th to M-th resource pools.

17. The communication apparatus of claim 14, wherein the processor is further configured to:
adjust, in a case where the first total candidate power is larger than the second maximum power, the first candidate power of each of the one or more PSFCHs for a target resource pool in the resource pools, to obtain a third candidate power of each of the one or more PSFCHs for the target resource pool; wherein a third total candidate power of the PSFCHs for the terminal device is less than or equal to the second maximum power, and the third total candidate power is determined based on the third candidate power and the first candidate power of each of the one or more PSFCHs for each of other resource pools in the resource pools;
determine the third candidate power of each of the one or more PSFCHs for the target resource pool as the actual transmission power of each of the one or more PSFCHs for the target resource pool; and
determine the first candidate power of each of the one or more PSFCHs for each of the other resource pools as the actual transmission power of each of the one or more PSFCHs for each of the other resource pools.

18. The communication apparatus of claim 12, wherein the processor is specifically configured to:
obtain an initial power, a compensation coefficient, and a downlink path loss reported by the terminal device; and
determine the one or more power control powers according to the initial power, the compensation coefficient, and the downlink path loss.

19. The storage medium of claim 11, wherein the computer is specifically configured to:
determine one or more power control powers of one or more PSFCHs for each of the one or more resource pools; and
determine the actual transmission power of each of the one or more PSFCHs for each of the one or more resource pools, according to the one or more power control powers, one or more first maximum powers of the one or more PSFCHs for each of the one or more resource pools, and a second maximum power of the PSFCHs supported by the terminal device.

20. The storage medium of claim 19, wherein the computer is specifically configured to:
for each of the one or more resource pools, determine a smaller power from the one or more power control powers and the one or more first maximum powers as a first candidate power of each of the one or more PSFCHs for each of the one or more resource pools; and
determine, according to the second maximum power and the first candidate power of each of the one or more PSFCHs for each of the one or more resource pools, the actual transmission power of each of the one or more PSFCHs for each of the one or more resource pools.

21. The storage medium of claim 20, wherein the computer is specifically configured to:
determine, according to the first candidate power of each of the one or more PSFCHs for each of the one or more resource pools, a first total candidate power of the PSFCHs for the terminal device; and
determine, in a case where the first total candidate power is less than or equal to the second maximum power, the first candidate power of each of the one or more PSFCHs for each of the one or more resource pools as the actual transmission power of each of the one or more PSFCHs for each of the one or more resource pools.
